(19) United States
(12) Patent Application Publication
(10) Pub. No.: US 2015/0152744 A1
(43) Pub. Date: Jun. 4, 2015

(54) STRUCTURAL PART MADE OF COMPOSITE MATERIAL SUCH AS A RAIL FOR A SLIDING COWL OF A THRUST REVERSER OF AN AIRCRAFT ENGINE NACELLE

(71) Applicant: AIRCELLE, Gonfreville L'Orcher (FR)

(72) Inventor: Loïc LE BOULICAUT, Le Havre (FR)

(21) Appl. No.: 14/611,662

(22) Filed: Feb. 2, 2015

Related U.S. Application Data
(63) Continuation of application No. PCT/FR2013/051873, filed on Aug. 2, 2013.

(30) Foreign Application Priority Data
Aug. 9, 2012 (FR) 12/57727

(51) Int. Cl. F01D 25/00; F01D 25/24; B32B 3/26

(52) U.S. Cl. CPC F01D 25/005; B32B 3/26; F01D 25/24; B32B 2605/18

(57) ABSTRACT

The present disclosure relates to a structural part made of a composite material, such as a rail for a slidable cowl of a thrust reverser of an aircraft engine nacelle. The structural part includes a main portion made of a composite material and a reinforcing portion made of a composite material. The main portion defines a groove, and the reinforcing portion is provided at the bottom of the groove. In particular, the reinforcing portion defines a bearing surface at the bottom of the groove.

### CROSS-REFERENCE TO RELATED APPLICATIONS

This application is a continuation of International Application No. PCT/FR2013/051873, filed on Aug. 2, 2013, which claims the benefit of FR 12/57727, filed on Aug. 9, 2012. The disclosures of the above applications are incorporated herein by reference.

### FIELD

The present disclosure relates to a structural part made of composite material such as a rail for a sliding cowl of a thrust reverser of an aircraft engine nacelle.

### BACKGROUND

The statements in this section merely provide background information related to the present disclosure and may not constitute prior art.

An aircraft engine nacelle includes a number of movable elements.

In particular, when this nacelle is equipped with a cascade-type thrust reverser, it may include one or more cowl(s) slidably mounted on fixed beams of the nacelle, thanks to systems of rails and slides interposed between these beams and these cowls.

The actuation of these sliding cowls is carried out by hydraulic or electric actuators.

In a continuing concern for weight gain, it is envisaged today to make the aforementioned beams and rails with composite materials.

It is thus shown in FIG. 1, in cross-section, a beam web 1 on which is fixed a rail 3 accommodating the slide 5 of a sliding cowl of a nacelle of a cascade-type thrust reverser.

The web 1 and the rail 3 are each formed by a stack of composite plies.

These plies are stacked so as to give the rail 3 a gutter shape, allowing to receive an end 7 of the slide 5 of corresponding shape.

The areas of connection 9a, 9b of the branches 11a, 11b of the gutter 3 with the bottom 13 of this gutter, are areas of high stress concentration.

These concentration areas require a considerable dimensioning of the rail 3, and therefore a significant increase in the weight of this rail.

### SUMMARY

The present disclosure provides a structural part made of composite material such as a rail for a cowl of a thrust reverser of an aircraft engine nacelle, this part comprising a main portion made of composite material defining a gutter shape, and a reinforcing portion made of composite material at the bottom of this gutter defining a bearing surface at the bottom of this gutter.

The reinforcing portion acts as an area of transition of forces. In the particular case where the part is a rail for a cowl of a thrust reverser of an aircraft engine nacelle, the reinforcing portion allows a transition of forces between the associated slide of the sliding cowl and the main portion of the rail: on the side of slide, this reinforcing portion exhibits a substantially planar surface allowing optimum distribution of forces exerted by the slide; on the side of the main portion of the rail, this reinforcing portion can conform to the shape of this main portion which is the most suitable for resuming the stresses generated by the slide.

In particular, thanks to the presence of this reinforcing portion, a main portion exhibiting a C-section can be chosen, the branches of which are connected at the bottom by areas with radii of curvature greater than those of a composite part of the prior art, thus limiting the stress concentration in these connecting areas.

The composite material forming the main and reinforcing portions of the structural part can be obtained by weaving, braiding, draping, etc. of glass or carbon fibers for example, followed by a resin polymerization step, as is known per se.

According to other features of this structural part:

said bearing surface is substantially planar;

said reinforcing portion comprises composite plies which partially conform to the inside of the gutter shape of said main portion: this allows preventing a stress concentration in the connecting area between the main portion and the reinforcing portion;

the main and reinforcing portions of said structural part are fixed together with reinforcing threads in the third dimension, disposed in alignment with the forces to enhance efficiency;

said main portion is closed at one of the ends of this structural part: this allows consolidating this structural part at this end: this is particularly useful when the structural part is a rail for a thrust reverser cowl, being noted that, as a general rule, the rail is subjected, from the associated slide, to greater stresses at its ends;

said reinforcement exhibits a shape adapted to the stresses to be absorbed.

The present disclosure also relates to an assembly comprising a beam formed at least partially of composite material and at least one structural part in accordance with the foregoing.

According to other features of the assembly according to the present disclosure:

said reinforcing portion protrudes from the ends of this structural part and is bent behind a portion of this beam: this bending of the reinforcing portion allows a greater resistance of the fixation of the structural part on the beam;

the main portion of said structural part is fixed on said beam by rivets;

said reinforcing portion includes counterbores for receiving these rivets;

the main and reinforcing portions of said rail are fixed together and to said beam with reinforcing threads in the third dimension, disposed in alignment with the forces to enhance efficiency.

The present disclosure also relates to an aircraft engine nacelle, noteworthy in that it is equipped with an assembly in accordance with the foregoing.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1 is a cross-sectional view of a beam, a rail and a slide of the prior art, described hereinabove;

FIG. 2 is a cross-sectional view of one form of a rail according to the present disclosure;

FIG. 3a is a cross-sectional view of another form of a rail according to the present disclosure;

FIGS. 3b and 3c are perspective views of an assembly of a beam and a rail in accordance with the form of FIG. 3a;

FIG. 4 is a partial sectional view of another form of a rail according to the present disclosure;

FIG. 5 is a perspective view of one end of another form of a rail according to the present disclosure;

FIG. 6 is a sectional view along the line VI-VI of the rail of FIG. 5;

FIG. 7 is a perspective view of one end of the slide able to cooperate with the rail shown in FIGS. 5 and 6;

FIG. 8 is a perspective view of a beam web in which we can see a particular mode of fixation of a rail in accordance with any one of FIGS. 2 to 7;

FIG. 9 is a sectional view of the assembly of FIG. 8 taken along the line IX-IX;

FIGS. 10 to 12 are cross-sectional views of different modes of fixation of a rail in accordance with the present disclosure on a beam web;

FIGS. 13 to 16 are cross-sectional views of other forms of rails according to the present disclosure, and

FIGS. 17 to 19 are sectional views of other applications of the present disclosure.

In all of these figures, identical or similar references designate identical or similar members.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

The terms “transverse” and “longitudinal” apply with respect to the greatest length of the rail according to the present disclosure.

Hereafter, we will focus in particular on a rail for a thrust reverser cowl in accordance with the present disclosure, but we will see at the end of the present description that the present disclosure can be applied more generally to any composite part exhibiting a curvature.

Referring now to FIG. 2, in which we can see that the rail 3 according to the present disclosure comprises in fact, on the one hand, a main portion 14 defined by composite plies that are superimposed so as to define a gutter shape, and on the other hand, a reinforcing portion 15 comprising composite plies that are superimposed at the bottom of this gutter, so as to define a substantially planar bearing surface 17 at the bottom of this gutter.

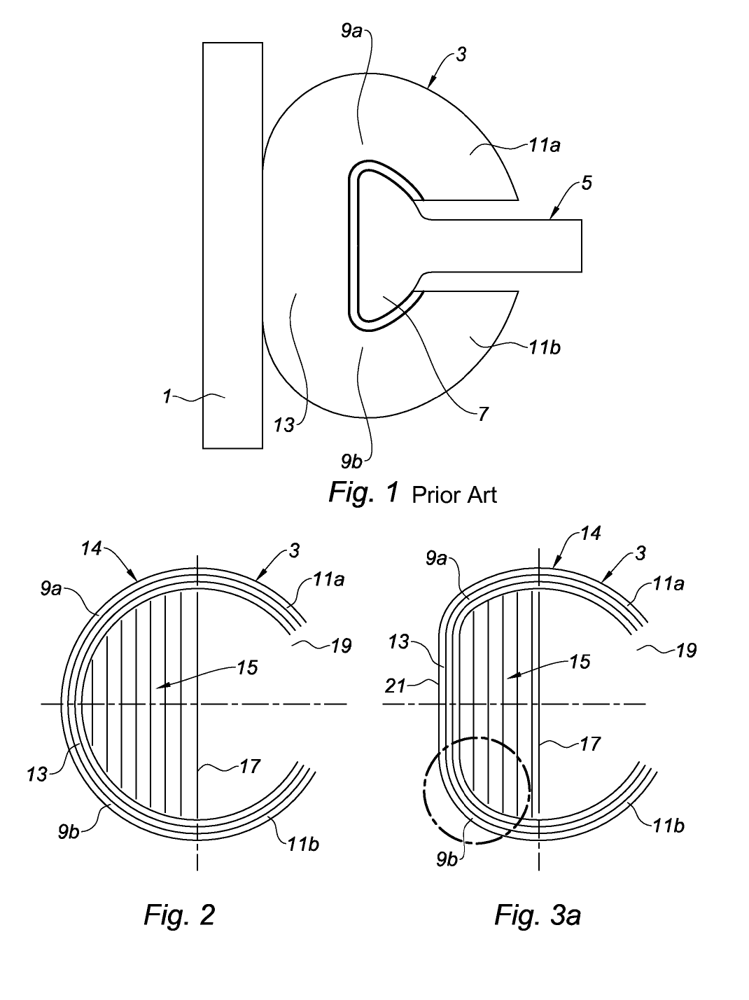

In the form of FIG. 2, the main portion 14 is substantially circular, with an opening in the shape of a groove 19 allowing to accommodate a slide in particular of a thrust reverser cowl (see FIG. 1).

In the example shown in FIG. 2, the composite stack defining the reinforcing portion 15 substantially fills the half of the cylinder defined by the main portion 14, but this is of course in no way restrictive.

It should be understood, of course, that the plies defining the main portion 14 and the reinforcing portion 15 are taken in the polymerized resin, conferring the thus obtained assembly with a very high resistance, as is known in the field of composite materials.

It will be noted that the main 14 and reinforcing 15 portions can be obtained from any other composite material manufacturing method: weaving, draping, braiding, sewing with fibers of carbon, glass, etc.

It is understood that the circular section of the main portion 14 allows reducing very substantially the stresses imposed to this main portion by the slide (not shown) likely to move inside this main portion 14, in contact with the inner surfaces of the rail (branches 11a and 11b): this reduction of the stresses in the areas 9a and 9b of the main portion 14 is allowed by the increase in the radius of curvature of this portion 14 in these areas.

In other words, the reinforcing portion 15 acts as a transition area, allowing on one side to create a proper geometry for the forces on the corresponding surface of the slide, and on the other side to permit a proper geometry for the slide.

Note however that this circular configuration of the main portion 14 is not ideal for allowing the fixation of the rail according to the present disclosure to a fixed beam of the nacelle: such a circular configuration results indeed in limiting the extent of the area of contact of the rail with the corresponding portion of the beam.

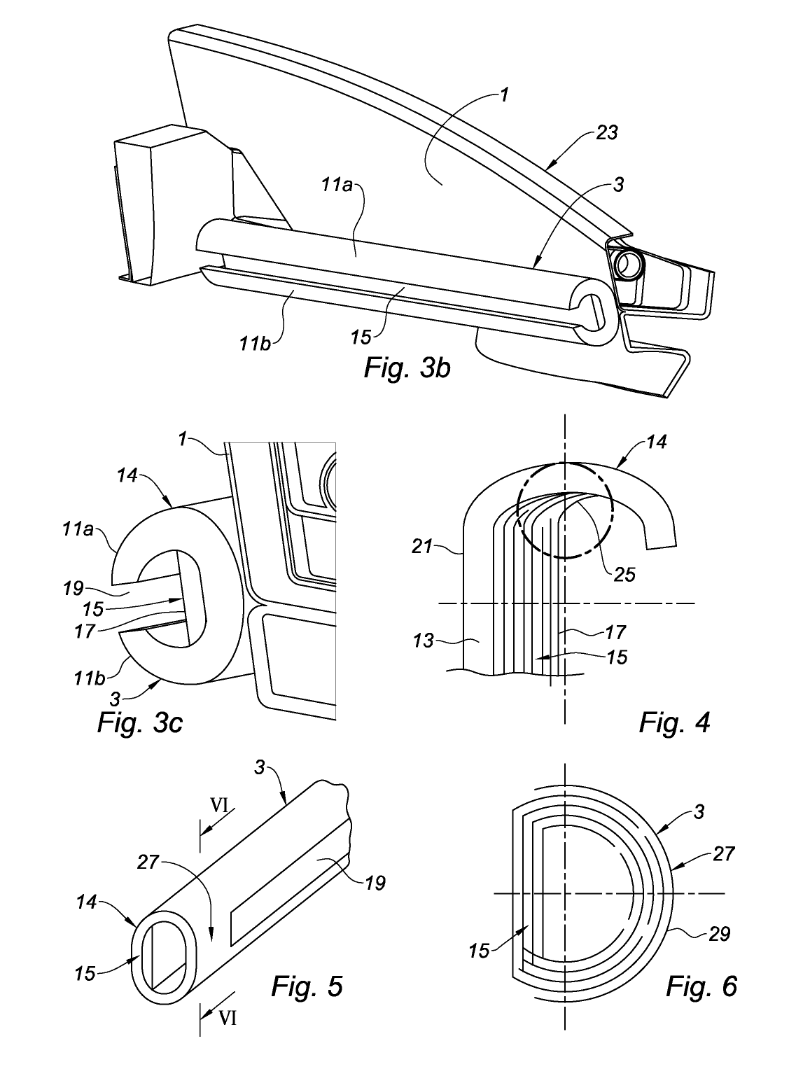

This is why we can usefully implement another form shown in FIGS. 3a to 3c, in which the area 21 of the main portion 14 of the rail which is intended to cooperate with a fixed beam of the nacelle 23, is flattened.

This configuration, although slightly less favorable than that of FIG. 2 with regards to the stress concentration, allows however to obtain the radii of curvature of the areas of connection 9a, 9b of the branches 11a, 11b with the bottom 13 of the rail 3, which are significantly larger than those of the prior art (see FIG. 1): in this way, the stress concentration in the main portion 14 (at the areas 9a and 9b) of the rail 3 can be considerably reduced.

FIG. 4 shows that it is possible to advantageously consider providing that the composite plies which define the reinforcing portion 15 of the rail, partially conform to the inside of the gutter shape of the main portion 14, as is indicated by the reference 25 in this FIG. 4.

In order to consolidate the rail according to the present disclosure, we can consider closing one 27 of these ends, as shown in FIGS. 5 and 6.

To this end, composite plies 29 for closing the end 27 of this rail are provided, as can be seen in particular in FIG. 6 (the plies draping is only an illustrative example, but can be replaced by any known mode for obtaining composite material).

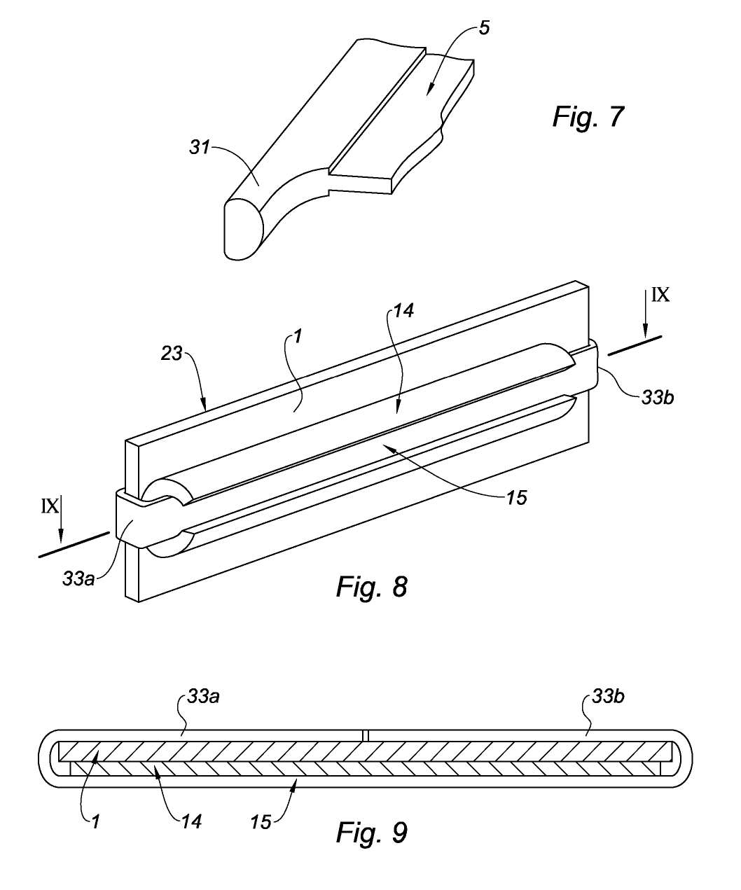

We can at this point usefully consider that the slide 5 exhibits an end 31 corresponding to the volume defined by the closed end 27 of the rail 3, as can be seen in FIG. 7.

In order to reinforce the fixation of a rail 3 in accordance with any one of FIGS. 2 to 6, on the web 1 of the associated beam 23, we can consider that the reinforcing portion 15 disposed at the bottom of the main portion 14 of the rail 3, exhibits over-lengths 33a and/or 33b which are bent behind the web 1, as can be seen in FIGS. 8 and 9: these bent over-lengths are taken in the resin of the web 1 during the polymerization, thus allowing to obtain an assembly of very high cohesion.

The length of each bend is depending on the passage of the forces to be carried out between the rail 3 and the web 1, as well as the space available at the back of this web. It is possible to reinforce these connections by sewing or tufting for example.

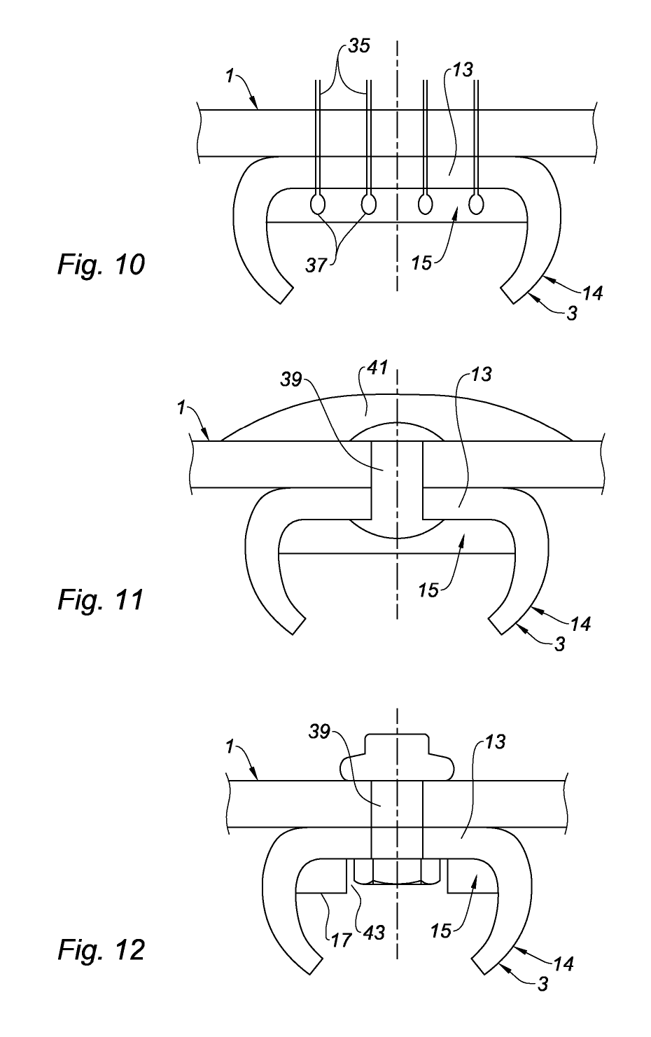

In FIGS. 10 to 12, various fixation means of the rail according to the present disclosure on the associated web 1 of the beam 23 are shown, which can be used alone or in combination with any one of the forms shown in FIGS. 2 to 9. The reinforcing portion 15 allows the integration of these fixation means.

In FIG. 10, we can see that the rail according to the present disclosure 3 is fixed on the web 1 by tufting, that is to say by taking in the resin of the web 1, of the main portion 14 and the reinforcing portion 15 of loops 37 of threads 35 (for example of carbon), disposed prior to the resin polymerization by the needles of an adapted machine.

Of course, any other type of three-dimensional connection, that is to say done by threads disposed along a direction substantially perpendicular to that of the web 1, may be appropriate.

As can be seen in FIG. 10, the loops 37 of the threads 35 are taken in the mass of the plies of the reinforcing portion 15, so that they require no modification of the resin injecting and composite-plies draping tool.

In the form shown in FIG. 11, conventional rivets 39 are used, which traverse the web 1 and the bottom 13 of the main portion 14 of the rail 3, the rivets 39 being covered, on the one hand, by the composite plies forming the reinforcing portion 15, and on the other hand, by additional plies 41 disposed on the other side of the web 1 with respect to the rail 3.

The form of FIG. 12 is in fact another form of the foregoing form, in which is considered a counterbore 43 of the composite plies defining the reinforcing portion 15 to the right of the rivets 39, that is to say, actually, a break of the reinforcing portion 15 to the right of these rivets 39, in such a way that they are set back with respect to the bearing surface 17 of this reinforcing portion 15, thus allowing the correct sliding of the associated slide.

This form can be used in particular during a repair, as a result of a damage of the part for example; the production of the counterbore 43 is carried out after polymerization of the reinforcing portion 15.

As can be understood in the light of the foregoing, the addition of a reinforcing portion 15 to the bottom of the main portion 14 of the rail 3 allows, on the one hand, to provide planar reception of the corresponding surface of the associated slide and, on the other hand, to adopt the proper geometry for the main portion 14 of the rail 3, with regards to the stress concentration issues.

It is possible in particular to confer this main portion 14 radii of curvature allowing to reduce the stress concentrations.

Thanks to this configuration, it is possible to reduce the dimensioning of the main portion 14 of the rail 3, and thus gain weight.

The present disclosure has been described in the particular context of a rail allowing the sliding of a cowl of a cascade-type thrust reverser, but it goes without saying that this present disclosure could be applied to any other sliding system of an aircraft engine nacelle.

More generally, the present disclosure could be applied to the reinforcement of any structural part made of composite material exhibiting a curvature.

Other forms and applications of the present disclosure will now be described.

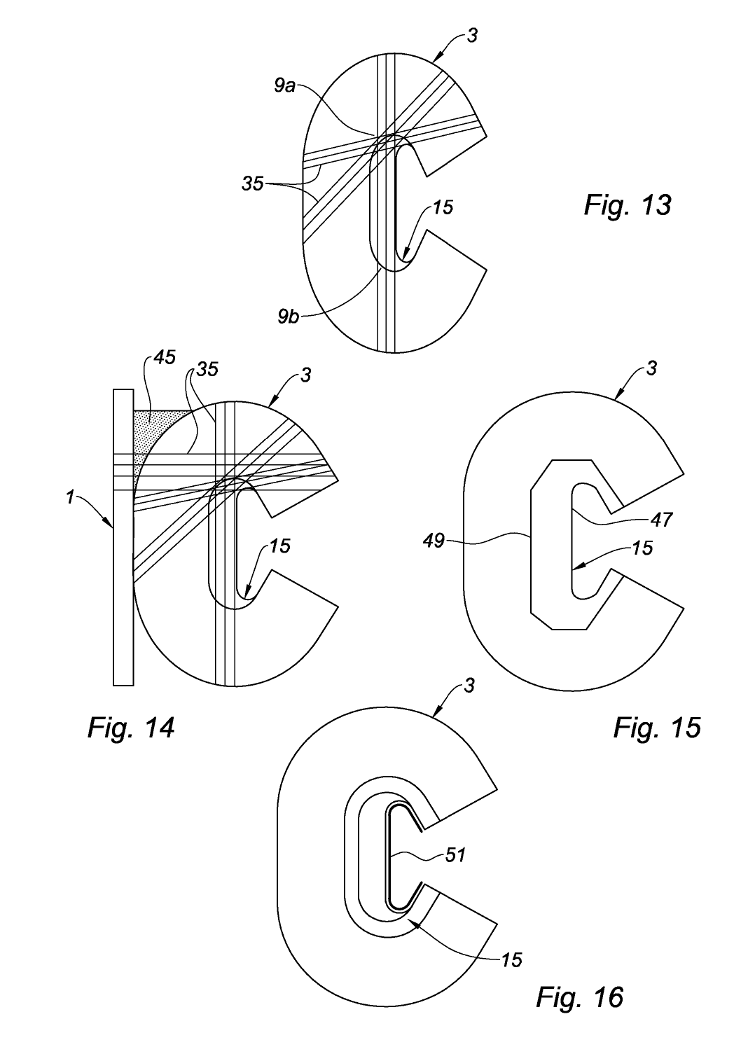

As can be seen in FIG. 13, the main portion 14 of the rail 3 can be traversed with reinforcing threads 35 (of glass or carbon, for example) as close as possible, and even within the areas 9a, 9b subjected to high stresses, thanks to the presence of the reinforcing portion 15 which is itself traversed by these threads. The orientation of these threads will be determined depending on the forces involved.

Without the presence of the reinforcing portion 15, these threads would be disposed in an area with no stress concentration, and their effectiveness would therefore be reduced.

In other form, as can be seen in FIG. 14, these threads 35 can also traverse the web 1, and thus allow reinforcing the fixation of the rail 3 on this web. Martyr areas can be added to improve the production cycle (installation of the reinforcing threads directly in the polymerization tooling). Depending on the final geometry, an addition of material (called “nail head”) may be necessary, as indicated by the reference 45 in FIG. 14.

Moreover, as can be seen in FIG. 15, the geometry of the reinforcing portion 15 can be adapted, so that it exhibits for example a curved inner section 47 and a polygonal outer section 49, depending on the forces to be taken back.

It will be noted also that machining the reinforcing portion 15 can be considered in order to obtain exactly the desired section, in which case sacrificial plies are provided during the manufacturing of this reinforcement.

Also, an insert, for example metallic, 51 can be incorporated inside the rail 3, on the reinforcing portion 15, as illustrated in FIG. 16.

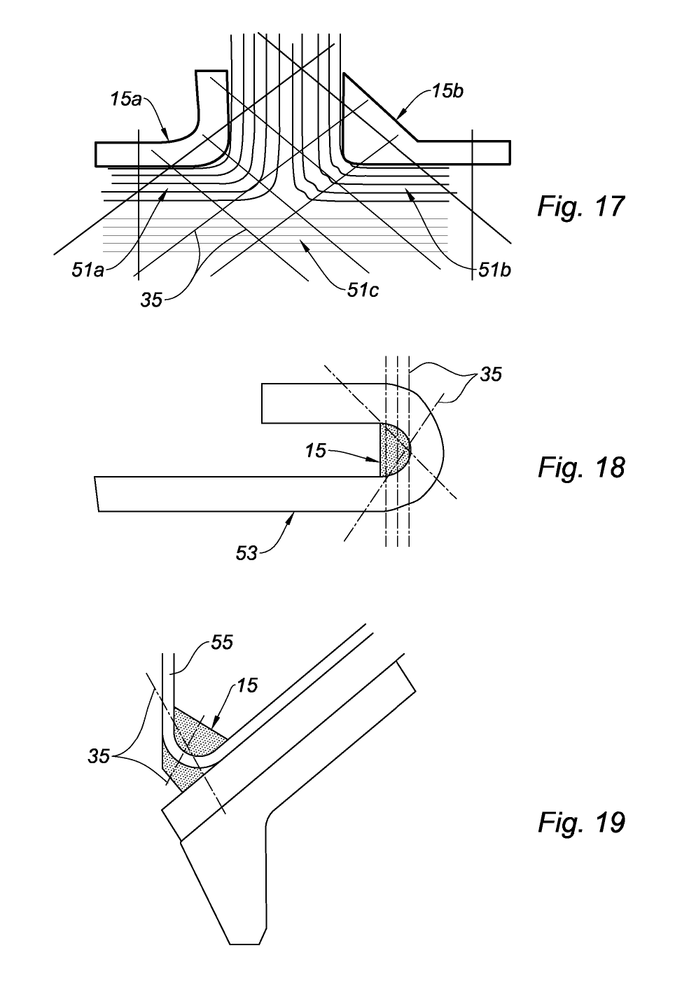

Other applications of the present disclosure can be seen in FIGS. 17 to 19.

In FIG. 17, the reinforcing portions 15a and 15b are disposed in the corners of a T-shaped connection between different series of composite plies 51a, 51b, 51c; in one form, reinforcing threads 35 traversing these plies and the reinforcing portions 15a, 15b so as to consolidate the whole.

In FIG. 18, a secondary thrust reverser composite rail 53, which normally exhibits a U-section which angles are of 90°, exhibits here a rounded section, inside which there is a reinforcing portion 15 traversed by reinforcing threads 35 in accordance with the precepts set out above.

In FIG. 19, we can see an L-shaped part 55 as part of a front-frame structure of a thrust reverser: in the elbow of this L-shaped part there is a reinforcing portion 15 traversed by reinforcing threads 35 in accordance with the precepts set out above.

What is claimed is:

1. A structural part made of composite material, the structural part comprising:
a main portion made of composite material and defining a gutter shape; and
a reinforcing portion made of composite material and defining at a bottom of the gutter shape a bearing surface at a bottom of the main portion.

2. The structural part according to claim 1, wherein the bearing surface is substantially planar.

3. The structural part according claim 1, wherein the reinforcing portion comprises composite plies which partially conform with an inside of the gutter shape of the main portion.

4. The structural part according to claim 1, wherein the main and reinforcing portions of the structural part are fixed together with reinforcing threads in a third dimension.

5. The structural part according to claim 1, wherein the reinforcing portion is traversed by the reinforcing threads.

6. The structural part according to claim 1, wherein the main portion is closed to an end of the structural part.

7. The structural part according to claim 1, wherein the reinforcing portion exhibits a shape adapted to stresses to be absorbed.

8. An assembly comprising a beam formed at least partially of composite material and at least one structural part according to claim 1.

9. The assembly according to claim 8, wherein the reinforcing portion protrudes beyond ends of the structural part and is bent behind a portion of the beam.

10. The assembly according to claim 8, wherein the main portion of the structural part is fixed on the beam by rivets.

11. The assembly according to claim 8, wherein the main portion of the structural part is fixed on the beam by at least one of sewing and tufting.

12. The assembly according to claim 10, wherein the reinforcing portion includes counterbores for receiving the rivets.

13. The assembly according to claim 8, wherein the main and reinforcing portions of the structural part are fixed together and to the beam with reinforcing threads in a third dimension.

14. A nacelle for an aircraft engine, comprising at least one assembly according to claim 8.
